(19) United States
(12) Patent Application Publication
(10) Pub. No.: US 2017/0032372 A1
(43) Pub. Date: Feb. 2, 2017

(54) Unattended Deposit System

(71) Applicant: Bank of America Corporation, Charlotte, NC (US)

(72) Inventor: Darrell Johnsrud, Washougal, WA (US)

(21) Appl. No.: 14/814,890

(22) Filed: Jul. 31, 2015

(51) Int. Cl. G06Q 20/40; G06Q 20/02

(52) U.S. Cl. CPC G06Q 20/405; G06Q 20/02; G06Q 20/40145; G06Q 20/4016

(57) ABSTRACT

Systems, methods, apparatuses, and computer-readable media for transferring funds from a first entity, such as a business, to an unattended deposit system of a second entity, such as a financial institution are provided. The funds may be transferred by a transport agent who, in some examples, may provide registration information, including biometric data, and for which a background check may be performed prior to the transport agent becoming an authorized transport agent. Upon making the deposit, the transport agent may provide identifying information, such as biometric data. This data may be compared to the registration information and, if it matches, the deposit may be permitted. If it does not match, the deposit may be prevented. The identifying information received by the system may be associated with a unique identifier assigned to the deposit transaction and the information may be stored to have a record of the individual making the deposit.

### BACKGROUND

Businesses, such as retail stores, restaurants, and the like, often collect various amounts of cash (e.g., paper currency and coins) throughout the day. In addition, checks or other negotiable instruments, foreign currency, and the like, may also be collected by businesses. These businesses must then transfer the collected funds from the location of the business to a bank or other financial institution for deposit. In conventional systems, a manager or senior employee of the business may collect the funds in a bag and transport the funds to the financial institution. In some larger businesses, an armored car service may collect the funds and transport them. However, these conventional systems merely allow the person making the deposit to drop off the funds. No tracking of the individual making the deposit, confirmation of the authorization of the individual to make the deposit, or the like is provided in these conventional systems.

### SUMMARY

Aspects of the disclosure relate to various systems, methods, apparatuses, and computer-readable media for transferring funds from a first entity, such as a business, to a second entity, such as a financial institution. In some examples, the funds may be transferred to and deposited at an unattended deposit system of the second entity. The funds may be transferred by a transport agent who, in some examples, may provide registration information and for which a background check may be performed prior to the transport agent becoming an authorized transport agent.

In some examples, the registration information may include biometric data. Accordingly, upon making the deposit of the funds at the unattended deposit system of the second entity, the transport agent may be requested to provide identifying information, such as biometric data. This data may be compared to the registration information and, if it matches, the deposit may be permitted, processed, or the like. If the information does not match, the deposit may be prevented. The identifying information received by the system may be associated with a unique identifier assigned to the deposit transaction being made (e.g., the deposit being made by the transport agent) and the information may be stored to have a record of the individual (transport agent) who made the deposit.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more aspects discussed herein;

FIG. 2 depicts an illustrative block diagram of workstations and servers that may be used to implement the processes and functions of certain aspects of the present disclosure in accordance with one or more aspects discussed herein;

FIG. 3 illustrates one example unattended deposit system in accordance with one or more aspects discussed herein;

FIGS. 4A and 4B illustrate one example event sequence for making a deposit using an unattended deposit system in accordance with one or more aspects described herein;

FIG. 5 illustrates one example method of making a deposit using an unattended deposit system according to one or more aspects discussed herein;

FIG. 6 illustrates one example method of authenticating a transport agent to process a deposit at an unattended deposit system in accordance with one or more aspects described herein;

FIG. 7 illustrates an example method of making a deposit using an unattended deposit system in accordance with one or more aspects discussed herein;

FIG. 8 illustrates one example user interface for registering a potential transport agent in accordance with one or more aspects discussed herein; and

FIG. 9 illustrates one example user interface for initiating a transaction at an unattended deposit system in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Aspects of this disclosure relate to systems and methods for transferring funds from a first entity, such as a retail location, to a second entity, such as a financial institution without user interaction at the second entity. In some examples, the systems and arrangements described herein allow for unattended deposit at an unattended deposit system of the second entity, such as a financial institution. The unattended deposit system may be similar to a deposit drop box or other after-hours deposit system and may include one or more computing devices, displays, user interfaces, and the like. In some examples, the unattended deposit system may allow for only deposit transactions. That is, no withdrawals, check cashing, or other functionality may be provided by the unattended deposit system. Only deposits may be conducted at the unattended deposit system, in at least some arrangements. Further, in some examples, the unattended deposit system is configured to accept packages (e.g., deposit packages, bags, containers, or the like) rather than cash, checks, or other funds directly (e.g., funds or checks inserted directed into the system without a package or container). The unattended deposit system also securely holds or contains the funds received which aids in maintaining a chain of custody of the funds, avoiding unauthorized access, and the like. In some examples, the system may identify (e.g., via scanning or otherwise detecting) the package upon receipt. In some arrangements, this may commence a deposit transaction, user authentication, or other step.

The systems and arrangements described herein may include authenticating a transport agent or other individual making the deposit (e.g., determining whether identifying information, such as biometric data, matches pre-stored identifying information before permitting the deposit to be processed). In other examples, pre-stored identifying information might not be used. Instead, a user may provide identifying information, such as biometric data, upon making the deposit and the data may be stored. If any issues arise with the deposit, the identifying information may be used to identify the transport agent who made the deposit and investigate the issues identified. These and other features will be described more fully below.

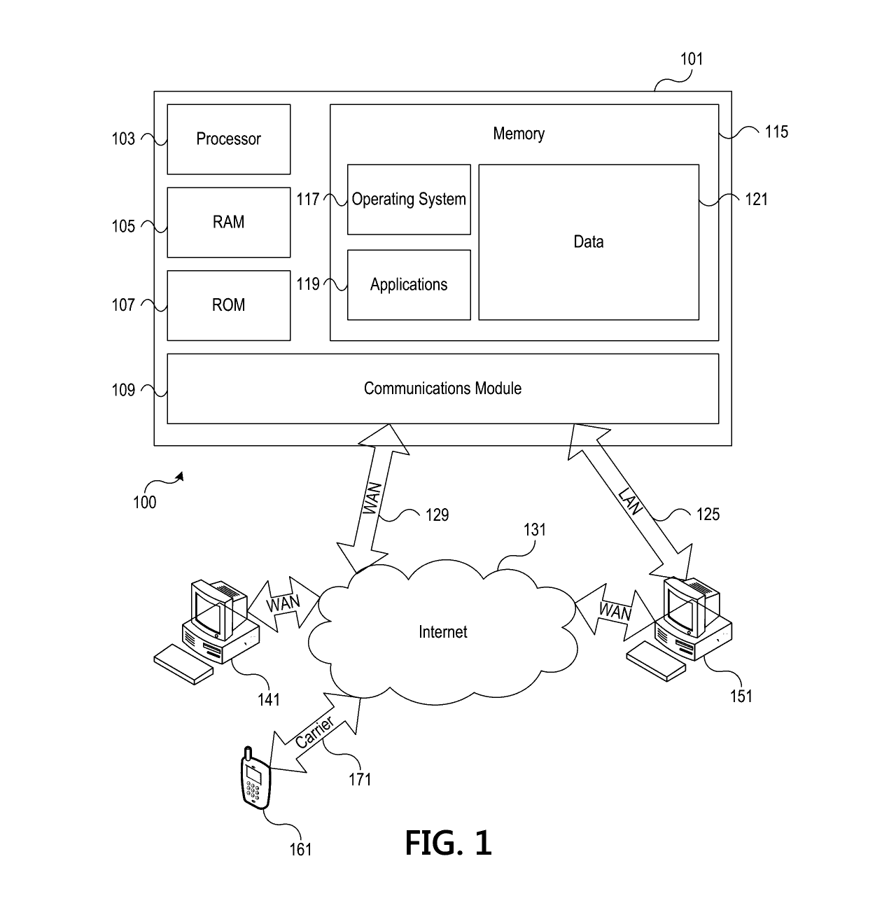

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include biometric scanning devices (not shown in FIG. 1) that may be used to receive biometric data from a transport agent, either for use in a registration process or for use in providing authenticating information to determine whether a deposit will be permitted, as will be discussed more fully herein. Additionally or alternatively, optical scanners (not shown) may be used for scanning and converting paper documents, e.g., correspondence, receipts, and the like, to digital files, scanning and identifying funds received via the deposit, such as cash, scanning and processing negotiable instruments received via the deposit, such as checks, converting negotiable instruments to digital files for processing, and the like.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like. In some examples, these known computing systems may be configured (e.g., with particular hardware, software, or combinations thereof) to perform the functions described herein. For instance, computing devices may be configured with particular hardware and/or software to perform the functions described herein (e.g., generating a unique deposit identifier, receiving identifying information, determining whether the received identifying information matches pre-stored information, and the like). In other examples, the computing device may be a special purpose computing device having particular components that are configured to perform the functions described herein.

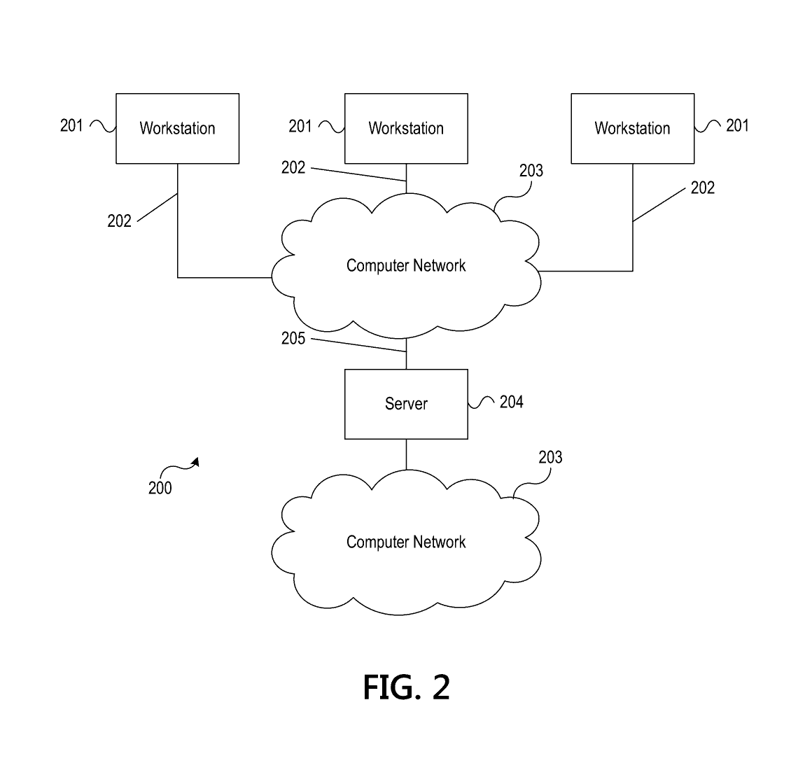

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like, that is configured to perform the particular functions described herein. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

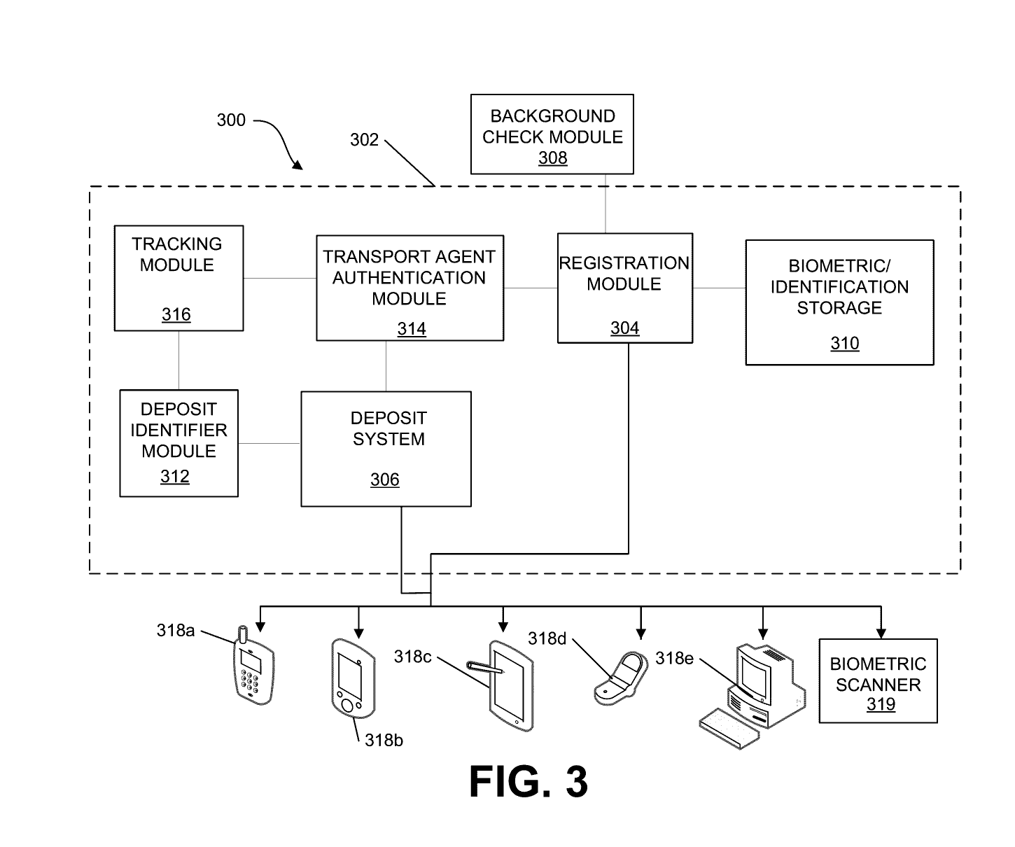

FIG. 3 illustrates one example unattended deposit system 300. In some examples, the unattended deposit system 300 may be associated with or part of an entity 302, such as a financial institution. The entity 302 may be one of various other types of entities without departing from the invention. The unattended deposit system 300 may be configured to receive one or more deposits from other entities, such as retail entities, restaurants, etc. that may collect funds throughout the day and may then transfer those funds to another entity for deposit (e.g., at close of business each day, each week, or on another periodic or aperiodic basis).

The unattended deposit system 300 of FIG. 3 may include one or more devices, systems, modules, and the like. Each of these devices, systems, modules, and the like, may be contained in the same physical location and/or in a single physical device. Alternatively, the devices, systems, modules, and the like, may be housed in multiple different physical devices located in a same or different, remote locations. Each device, system, module, and the like, may include one or more components of the computing device 101 discussed above and may include hardware and/or software configured to perform particular functions within the system.

For instance, the unattended deposit system 300 may include a registration module 304. The registration module 304 may include hardware and/or software configured to interface with a user (e.g., via one or more of computing devices 318a-318e and/or biometric scanner 319 to receive registration information. For instance, the registration module 304 may generate one or more user interfaces to provide to a potential transport agent in order to register the transport agent (e.g., to authorize the transport agent to pick up deposits, transport them to the second entity, and/or deposit them at the unattended deposit system of the second entity). In some examples, the registration module 304 may provide user interfaces via one or more of computing devices 318a-318e. For instance, the registration module 304 may generate and provide a user interface via a smart phone 318a, personal digital assistant 318b, tablet computing device 318c, cell phone 318d, or other computing device 318e. The computing device 318a-318e may be a computing device of or associated with the potential transport agent (e.g., the mobile phone of the potential transport agent) or may be a computing device used by various individuals and associated with one or more of the first entity (e.g., the entity at which the deposit is collected and picked up by the transport agent), the second entity (e.g., a financial institution at which the deposit will be made), or other entity (e.g., another entity providing registration type services, such as another financial institution different from the second entity, an armored car service, and the like).

The registration information provided to the registration module 304 from the potential transport agent may include a name, social security number or other unique identifier, driver's license number and state of issuance, username and password, contact information (e.g., address, phone number, email address, and the like). Various other types of registration information may also be provided by the potential transport agent. For instance, biometric data of the potential transport agent may be provided. Generally, biometric data includes biological data of an individual that may be used for identification purposes, verification purposes, and the like. Biometric data provides a repeatable measurement that may be used to identify a person or confirm identity of a person (e.g., matching biometric data previously collected to biometric data currently collected). The biometric data may be received from biometric scanning devices associated with one or more of computing devices 318a-318e and/or may be received from a separate biometric scanning device, such as device 319. The biometric data my include fingerprint data, retinal scan data, facial scan data, scans to identify aspects of hand geometry (e.g., finger length, hand shape, or the like), blood vessel recognition data (e.g., veins or other blood vessels in hand or finger), ear shape data, iris recognition data, or the like. In some arrangements, the received biometric data may be stored in a biometric data/identifying information storage module or device 310. The biometric data/identifying information storage module or device 310 may be configured to store data using one or more known methods (e.g., data tables, and the like) that may be sorted in various ways (e.g., by name of transport agent, unique identifier of transport agent, and the like). The biometric data/identifying information module or device 310 may be configured to store data permanently (e.g., until selected data is deleted or removed) or may store data on a temporary basis (e.g., pending confirmation of no issues with the deposit transaction), as will be discussed more fully herein.

Registration information received by the registration module 304 may then be used to determine, e.g., by a deposit system 306, by the registration module 304, by the unattended deposit system 300, or the like, whether the potential transport agent may be authorized to be a transport agent. For instance, background checks may be performed (e.g., by background check module 308, to determine whether any issues exist with the potential transport agent. The background check module 308 might not be associated with the entity 302, as shown in FIG. 3, (e.g., may be a third party provider of background check information), or may be part of the entity 302. The background check may include a review of any criminal history of the potential transport agent, a review of a credit history of the potential transport agent, as well as a review of the accuracy of information provided by the potential transport agent. In some examples, the background check performed by the background check module 308 may include a comparison of the information provided by the potential transport agent to known information associated with most wanted lists, a potential terrorist watch list, and the like.

In some examples, the system may provide for registration of different levels of transport agents. For instance, a basic registration may be performed for agents who may transport only dollar amounts below a threshold limit. These agents may provide biometric data but might only have a limited background screening (e.g., first level of background check). Another level of registrant may be permitted to transport funds above the threshold limit. These agents may provide biometric data and may have a more thorough background check performed upon registration (e.g., a second level of background check that is higher or more thorough (e.g., reviews more aspects of the individual) than the first level).

An outcome of the background check performed may determine whether the potential transport agent may be authorized to become a transport agent or may be denied. The outcome of the background check may be communicated to the potential transport agent via one or more of computing devices 318a-318e. Thus, in some arrangements, the registration information may be received prior to a transport agent (or potential transport agent) collecting a deposit at a first entity to transfer and deposit the funds at the second entity. The registration process may be performed at or via the financial institution or other external (e.g., third party or entity different from the first entity or second entity) registration service that is a trust entity of the financial institution. In some examples, the third party registration service may hold or store the biometric data for user in verifying an agent. Thus, any biometric data received at the unattended deposit system for verification may be matched with biometric data provided at registration that is stored at the financial institution and/or at the third party registration service (e.g., comparison may be performed at the second entity or third entity).

In some example arrangements discussed herein, no registration of a potential agent may be desired. Accordingly, the devices and processes discussed with respect to registration might not be included in those processes. For instance, in examples in which biometric data is collected at the unattended deposit system for use in auditing or investigating issues with a deposit, no validation may be performed and instead the data will be collected at the system and stored until needed or removed, as will be discussed more fully herein.

The unattended deposit system 300 may further include a deposit system 306. The deposit system may include hardware and/or software configured to perform various functions within the unattended deposit system 300. For instance, the deposit system 306 may be configured to receive a deposit (either funds directly or a device containing the funds) (e.g., via a slot, drawer or other deposit receptacle). In some arrangements, the deposit system 306 may receive an indication of an upcoming deposit. For instance, the deposit system 306 may receive an indication of an upcoming deposit from, for instance, one or more of computing devices 318a-318e that may be associated with or located at the first entity. For instance, a notification may be transmitted from a computing device of the first entity, such as a retail location, restaurant, or the like, that a deposit is being transferred. In some examples, the notification may include an expected amount of the deposit amount being transferred. In some arrangements, the notification may include an identifier associated with a transport agent who will be transporting the deposit from the first entity to the second entity. In some examples, receipt of the notification by the deposit system 306 may initiate a deposit transaction process.

In other examples, the deposit system 306 might not receive a notification of an upcoming deposit from the first entity and, instead, may initiate the deposit transaction when the transport agent arrives at the unattended deposit system 300 with the deposit. The transport agent may use one or more user interfaces provided by the deposit system 306 (e.g., via one or more of computing devices 318a-318e) to provide deposit initiating information, such as a request to deposit funds, an amount of funds being deposited, a name or identifier of the first entity from which the funds are received (e.g., to identify an account to which the funds should be deposited) or the like.

Upon initiating the deposit, the deposit system 306 may request generation of a unique identifier for the particular deposit from a deposit identifier module 312. For instance, the system may request that a unique identifier to associate with and identify the particular deposit transaction be generated. The unique identifier may be an alpha-numeric string and may be assigned to the deposit transaction and, in some examples, may be stored with transaction data, transport agent data, and the like. Once the unique identifier has been generated, it may be transmitted to the deposit system 306 for assignment to or association with the particular deposit transaction.

Once the deposit transaction has been initiated, the deposit system 306 may request identifying information from the transport agent making the deposit in order to authenticate the transport agent. For instance, in conventional systems, the deposit may be made to a tell or other instrument that may confirm an identity of the transport agent (e.g., by reviewing photo identification of the transport agent, or the like). However, the unattended deposit system 300 may not have a user to verify an identity of the transport agent. Accordingly, the system may authenticate the transport agent using various other methods of authentication.

For instance, the deposit system 306 may request (e.g., via a user interface displayed on one or more of computing devices 318a-318e) identifying information from the transport agent (e.g., the user dropping off or making the deposit at the unattended deposit system 300). The requested identifying information may include a name or other identifier of the transport agent, a password, and/or biometric data. The deposit system 306 may then receive the requested information from one or more of the computing devices 318a-318e. In the instance of biometric data, the deposit system 306 may receive the biometric data from the transport agent from a biometric scanning device associated with one or more of devices 318a-318e (e.g., a fingerprint scanner on a smartphone) and/or from a separate biometric scanning device 319.

In some examples, the received identifying information may be compared to pre-stored information by the transport agent authentication module 314 to authenticate the transport agent making the deposit. The transport agent authentication module 314 may include hardware and/or software configured to receive the identifying information provided by the transport agent (e.g., either directly from the computing device and/or from the deposit system 306) and compare the received information to identifying information stored in the biometric data/identifying information module or device 310. The comparison may include attempting to match, for instance, biometric data received from the transport agent to biometric data for the identified transport agent stored in the biometric data/identifying information module or device 310 (e.g., during the registration process). If the received information matches the pre-stored information, the deposit transaction may be permitted. If not, the transaction may be denied.

In some arrangements, one or more aspects of the processes and functions provided by the unattended deposit system may be tracked, such as via tracking module 316. The tracking module 316 may include hardware and/or software configured to receive information, such as a unique identifier of a deposit, a transport agent that attempted to make the deposit, time and date of the attempted deposit, whether the transport agent was authenticated, and the like. This information may be logged and may be used to identify and/or investigate any issues that may arise with a deposit. Additionally or alternatively, the information may be used to provide historical data of deposit transactions, and the like.

These and other arrangements will be discussed more fully below.

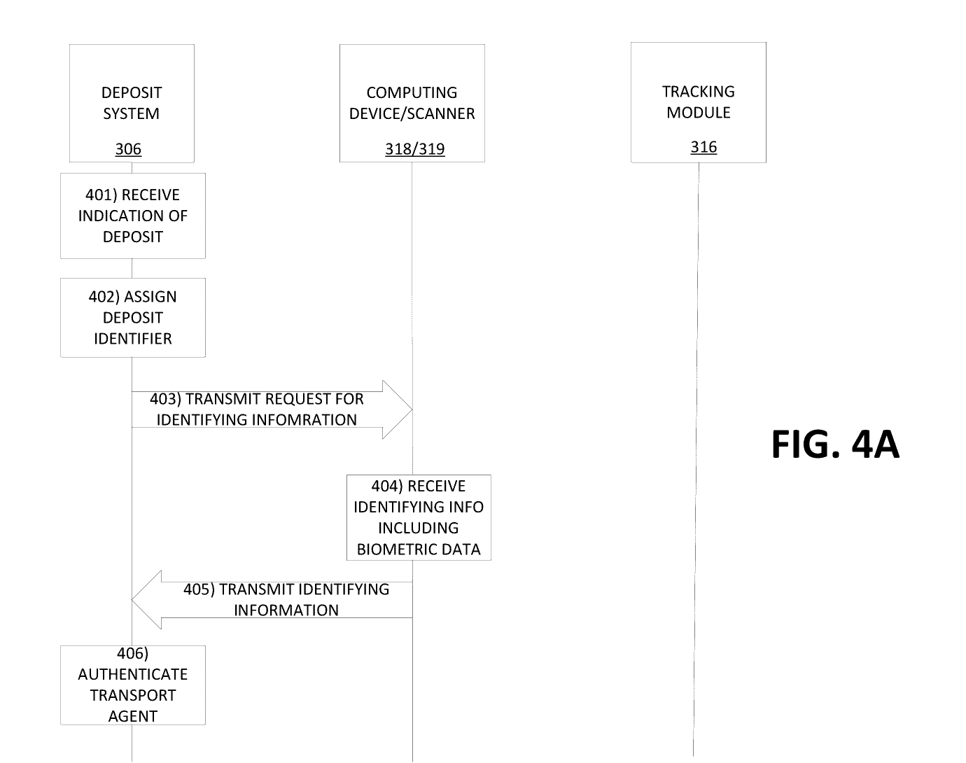

FIGS. 4A and 4B illustrate one example event sequence for making a deposit using the unattended deposit system, according to one or more examples discussed herein. The example shown in FIGS. 4A and 4B is merely one example sequence and various other steps, processes, or the like, may be included in this or other example sequences without departing from the invention.

With reference to FIG. 4A, in step 401, an indication of a deposit initiation may be received. For instance, the deposit system 306 may receive an indication of a deposit. The indication may be received from the first entity (e.g., a computing device of the first entity) making the deposit, or may be received from a transport agent (e.g., a user dropping off or making the deposit). The indication may be received from a separate computing device or from a user interface connected to or associated with the deposit system 306 (e.g., at the deposit system device into which the funds are placed for deposit).

In step 402, a deposit identifier may be assigned to the initiated deposit. For instance, a deposit identifier module may generate a unique identifier for the initiated deposit and that unique identifier may be associated with or assigned to the deposit transaction.

In step 403, a request for identifying information may be transmitted from the deposit system 306 to a computing device, such as computing device 318. In step 404, the identifying information may be received by the computing device 318 (or biometric scanner 319 in the case of biometric data) and the received information may be transmitted to the deposit system in step 405.

In step 406, the transport agent may be authenticated based on the received identifying information (e.g., via one or more processes discussed herein). In examples in which the transport agent is authenticated, the deposit transaction may be permitted in step 407 and may be further processed. For instance, in some examples, an amount of the deposit (e.g., as received from the first entity or from the transport agent) may be credited to an account of the first entity upon receipt of the funds. In some examples, the credit may be a provisional credit (e.g., a portion of the funds may be immediately available and a portion may be held). In another example, the full amount of the deposited funds may be immediately available for withdrawal.

In step 408, the unique deposit identifier may be associated with the identified transport agent and the identifying information for the transaction and transport agent may be stored. This information may be stored permanently (e.g., until deleted by a user) or may be temporarily stored (e.g., stored for a predetermined time period and deleted). In step 409, the identifying information may be transmitted to the tracking module 316 for storage.

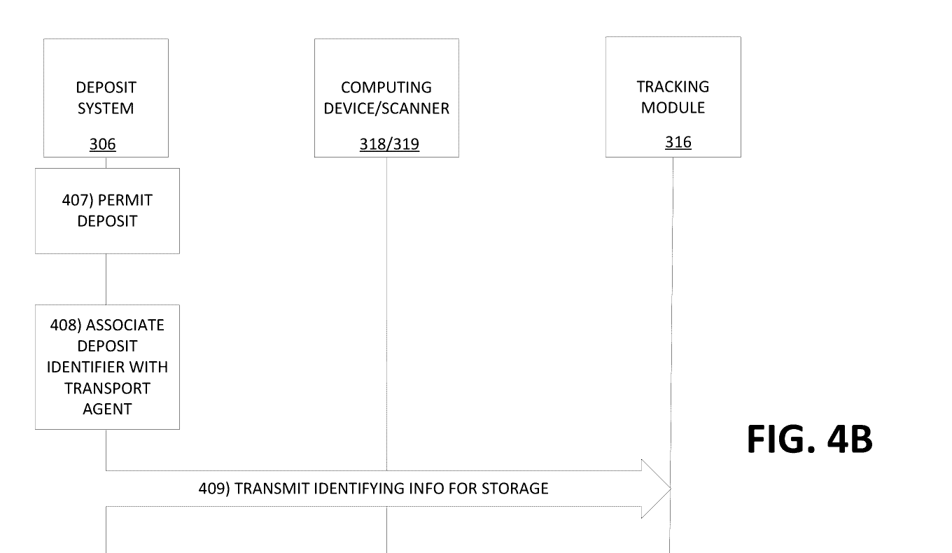

FIG. 5 illustrates one example method of making a deposit at an unattended deposit system according to one or more aspects described herein. In step 500, registration information may be received. As discussed above, registration information may include information associated with an identity of a potential transport agent, biometric data, and the like. In some examples, registration information may be received for a plurality of potential transport agents, such that, if approved, a plurality of transport agents may be available to make deposits using the unattended system.

In step 502, an indication of a deposit may be received. As discussed herein, the indication of deposit may be received from the first entity (from which the deposit is being received) in advance of the deposit arriving at the unattended deposit system, or may be received upon the transport agent arriving at the unattended deposit system with the deposit of funds. In step 504, a unique identifier may be generated and associated with or assigned to the deposit transaction.

In step 506, identifying information may be requested from the transport agent. The identifying information may include a name or other identifier, username and password combination, and/or biometric data. In some examples, only biometric data may be used as identifying information. The requested identifying information may be received in step 508 and, in step 510, a determination may be made as to whether the transport agent is authenticated.

If, in step 510, the transport agent is authenticated, the deposit may be processed in step 512. In step 514, a presence of the transport agent (e.g., the identifying information) may be recorded and the unique identifier associated with the deposit may be associated with the information identifying transport agent. All of this information may be stored in, for instance, a tracking module.

If, in step 510, the transport agent is not authenticated, the deposit may be prevented in step 516. In some examples, preventing the deposit may include physically preventing the transport agent from the placing the funds for deposit into the receiving device (e.g., the deposit system). In other examples, preventing the deposit may including permitting the transport agent to place the funds into the system but not credit will be provided to the account of the first entity and the funds may be held until they can be confirmed, processed, and the like, by, for instance, a banking associate of the financial institution. This may delay processing of the deposit because the additional processing might not occur until the next business day.

In step 518, the unique identifier of the deposit transaction, as well as identifying information provided by the transport agent, and an indication of an attempted but not authenticated login may be stored, such as in a tracking module. This information may be used to further process the transaction when ready, investigate any issues with the deposit (e.g., discrepancies in an amount of funds), and the like.

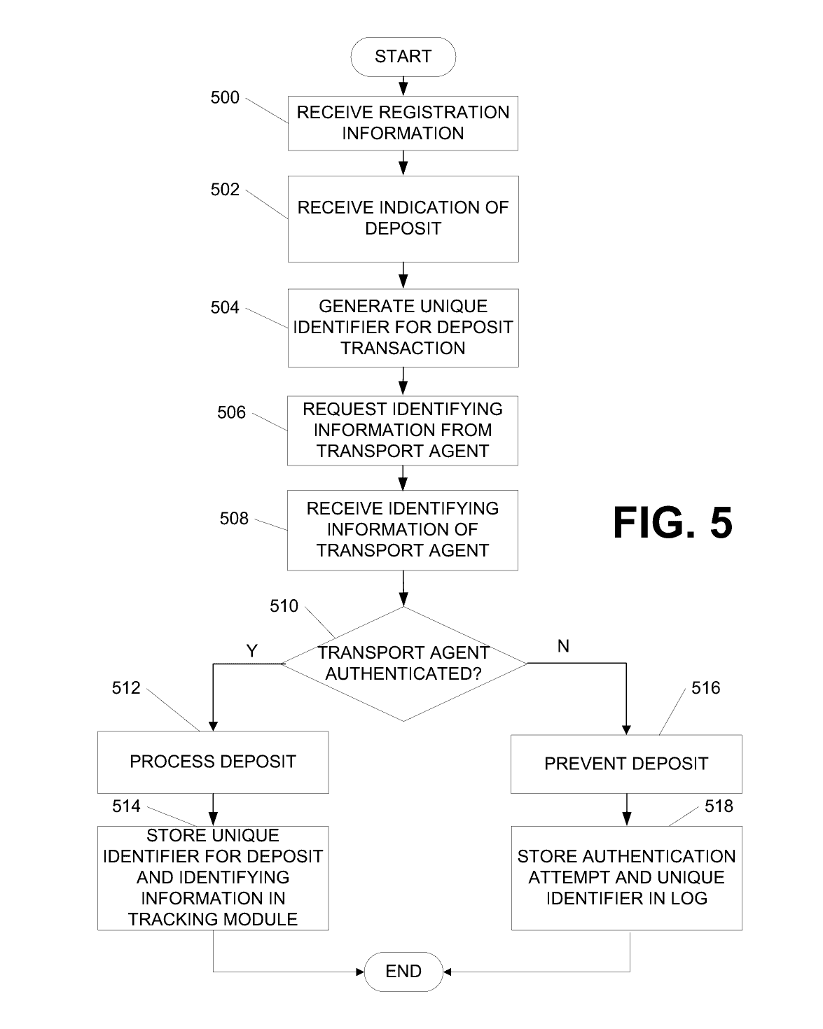

FIG. 6 illustrates one example method of authenticating a transport agent according to one or more aspects described herein. In step 600, registration information, including biometric data, may be received. In step 602, the received information, including the biometric data may be stored. In some examples, step 600 and 602 may be performed prior to a deposit being initiated, such that the identifying information, including the biometric data, may be pre-stored.

In step 604, identifying information, including biometric data, may be received from a transport agent at an attempted deposit. In step 606, a determination is made as to whether the received identifying information, including the biometric data, matches the pre-stored biometric data and/or identifying information. If so, the information may be stored and the deposit may be processed in step 608. If not, the deposit may be denied and the attempted authentication may be logged and stored for future processing, investigation, and the like, in step 610.

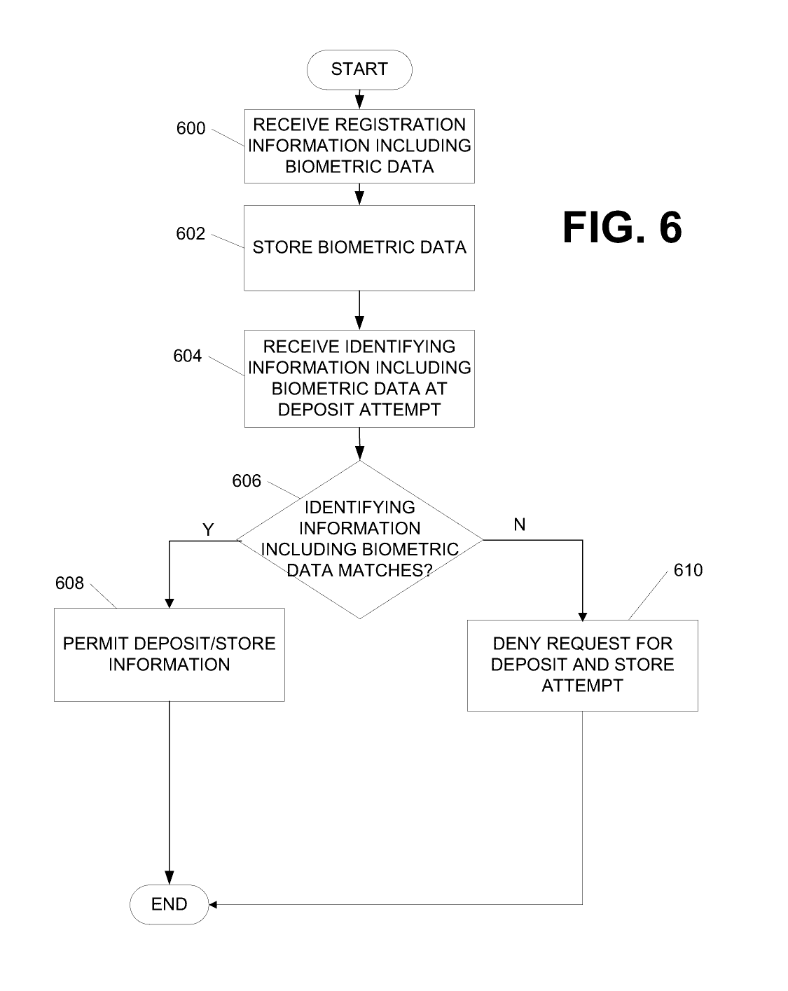

FIG. 7 illustrates another example method of conducting or attempting to conduct a deposit transaction at an unattended deposit system according to one or more aspects described herein. In the arrangement of FIG. 7, no registration process is included. Accordingly, limited or no pre-stored identifying or biometric data is available for comparison. For instance, the only pre-stored information may be a name of the transport agent, an agency associated with the transport agent (e.g., an armored car service) or the like. In step 700, a deposit request or initiation of a deposit may be received by the system. For example, as discussed above, an initiation of a deposit may be received from the first entity from which the deposit is being received. In other examples, the deposit may be initiated (e.g., requested) by a transport agent at the unattended deposit system. Initiation of the deposit may also include generating and assigning a unique identifier to the deposit transaction.

In step 702, identifying information of the transport agent may be requested. The requested information may include biometric data of the transport agent. In step 704, the requested identifying information, including biometric data, may be received and stored. In step 706, the deposit may be permitted. For instance, the transport agent may physically place the funds (or container carrying the funds) into the deposit system for deposit. The transaction may then be processed.

In some examples, processing the transaction might not occur until a next business day. Accordingly, the transport agent may have simply dropped off the deposit, provided identifying information, and left. Thus, in step 708, any issues with the deposit transaction may be identified. For instance, if a discrepancy exists between an expected amount of the deposit (e.g., an amount indicated by the transport agent or the first entity) and the actual amount of the deposit, the transaction may be flagged as having an issue. In another example, if funds received are damaged, the transaction may be flagged as having an issue. Various other issues may cause a transaction to be flagged without departing from the invention.

If no issues are identified in step 708, the stored identifying information of the transport agent may be deleted in step 714. Alternatively, if one or more issues are identified in step 708, the stored identifying information may be retrieved in step 710 and, in step 712, the identified issues may be investigated.

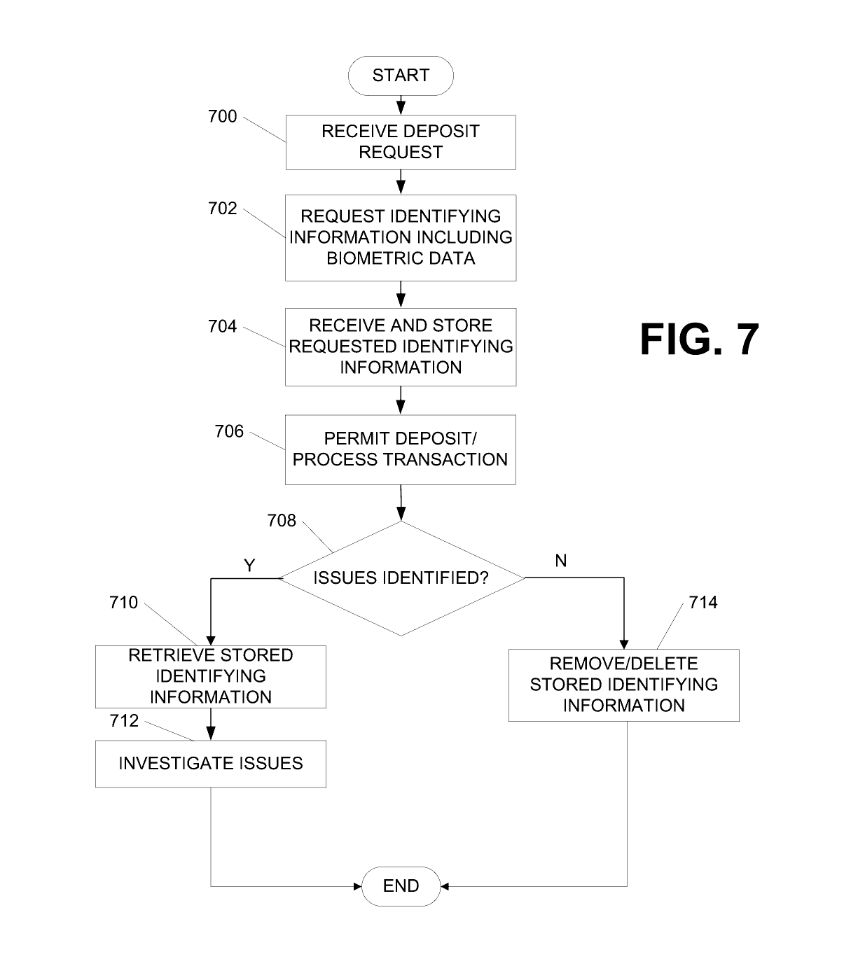

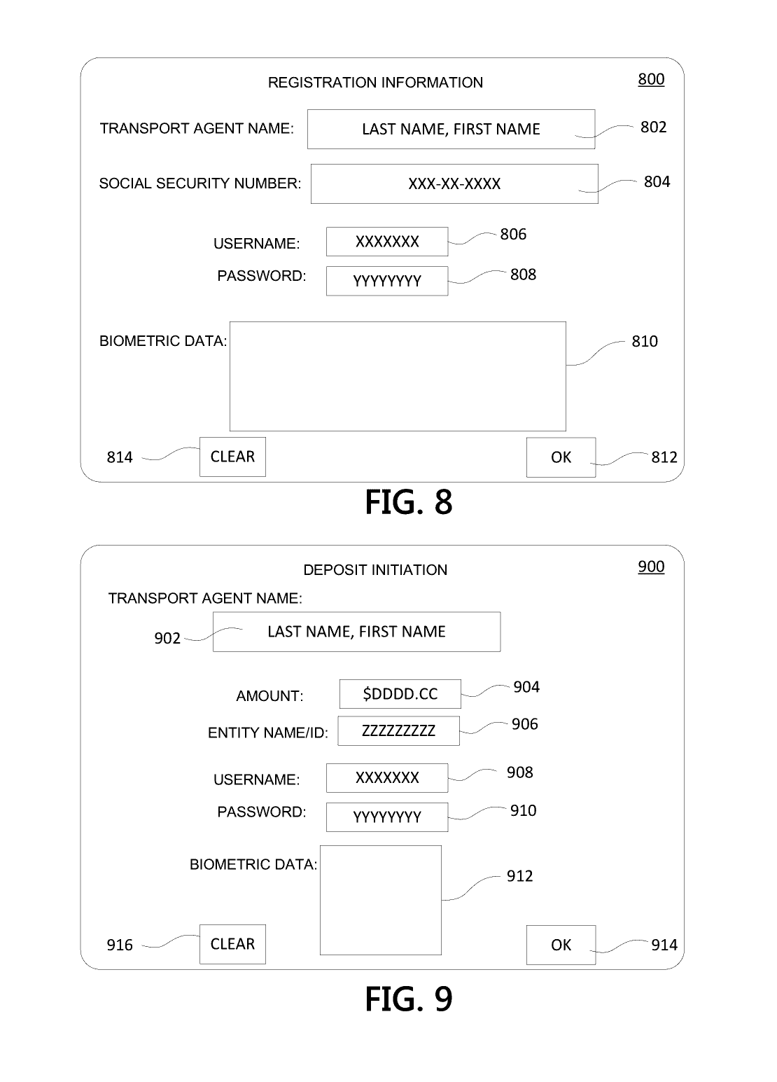

FIGS. 8 and 9 illustrate various user interfaces that may be used with the unattended deposit system. The user interfaces shown and described are merely example user interfaces and are not intended to limit the arrangements discussed herein to only use with these interfaces.

FIG. 8 illustrates one example user interface for providing registration information that may be used to authenticate a transport agent according to one or more examples discussed herein. The interface 800 includes region 802 in which a potential transport agent may provide his or her name. In region 804, the potential transport agent may provide a social security number. In fields 806 and 808, the potential transport agent may provide a username and password, respectively, which may be used to access the system, authenticate the transport agent, and the like. In region 810, the user may provide biometric data. The biometric data may include fingerprints, retinal scans, facial scans, and the like. The information provided in interface 800 may be used to conduct one or more background checks (e.g., credit history, criminal history, fingerprint check, and the like) to determine whether the potential transport agent may be authorized as a transport agent. Once the desired information has been entered, the potential transport agent may select “OK” option 812 to process the registration information. Alternatively, the potential transport agent may select “CLEAR” option 814 to clear all information provided in user interface 800.

FIG. 9 illustrates one example user interface for initiating a deposit transaction according to one or more aspect described herein. The interface 900 may be used to initiate the deposit transaction by the transport agent at the unattended deposit system. Similar user interfaces may be used to initiate the transaction at the first entity (e.g., interfaces in which the entity provides an identifier, amount, and the like). The interface 900 includes region 902 in which a transport agent may provide his or her name. The agent may then enter an amount of the deposit in field 904 and a name or identifier of the entity from which the deposit is being received in field 906. In regions 908 and 910, the transport agent may provide a username and password, respectively, which may be used in an authentication process. Further, in region 912, the user may provide biometric data. In some examples, the biometric data may be collected by a separate device (e.g., biometric scanner 319). In those examples, the user may select the biometric data label or region 912 and the user may be prompted to provide the biometric data via the separate device.

Once the desired information has been entered, the user may select “OK” option 914 to authenticate the transport agent and/or process the deposit. Alternatively, the user may select “CLEAR” option to remove all information entered into the fields in interface 900.

As discussed herein, the systems and arrangements described provide for recording identifying information of a transport agent. Accordingly, in at least some arrangements, this information may be stored and can be used to show, for instance, a chain of custody of a particular deposit. In some industries, agencies, such as government agencies, have regulations that may require that an identity of a person making a deposit be verified at the deposit, recorded and/or stored. In conventional systems, that would require the presence of a banking associate to receive the deposit. In the systems and arrangements described herein, the deposit system may be unattended (e.g., no banking associate may be at the system to receive deposits, verify an identity of a user, or the like) but the identity of the individual or transport agent making the deposit may be received and/or recorded. This allows for deposits to be made outside of normal business hours (e.g., normal banking hours, on holidays, on weekends, or the like) while still being able to identify and track transport agents making a deposit.

Although various arrangements discussed herein describe the unattended deposit system as being located at the second entity (e.g., at a financial institution), the unattended deposit system may be located virtually anywhere and may be configured to communicate with the second entity. For instance, the unattended deposit system might not be located at a branch or other banking location of the second entity and, instead, may be located in an area central to the retails establishments (e.g., first entity) that may be making deposits. In one example, if several stores located in a shopping mall or center make deposits with the second entity, an unattended deposit system may be set up at the mall or shopping center to allow for convenient deposits without requiring a fully banking center or branch. Various other example arrangements may be used without departing from the invention.

In some examples, the systems and arrangements discussed herein may include authorizing a plurality of transport agents to transfer and/or make deposits for a variety of different entities (e.g., a plurality of first entities). Accordingly, in some arrangements, a transport agent may be specific or particular to a first entity (e.g., authorized to make deposits for only one first entity), while in other arrangements, a transport agent may be authorized to make deposits for a plurality of different entities (e.g., different companies, retail stores, restaurants, or the like).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the modules, systems, devices, control systems, and the like, discussed above may be combined into a device, and the various functions of each module may be performed by the single computing device. In such arrangements, any and/or all of the above-discussed communications between modules, systems, devices, control systems, and the like, may correspond to data being accessed, moved, modified, updated, and/or otherwise used by the single computing device. Additionally or alternatively, one or more of the modules, systems, devices, control systems, and the like, discussed above may be implemented in one or more virtual machines that are provided by one or more physical computing devices. In such arrangements, the various functions of each module, system, device or control system may be performed by the one or more virtual machines, and any and/or all of the above-discussed communications between modules may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system, comprising:
a biometric scanner;
a processor;
a memory operatively coupled to the processor and storing computer-executable instructions that, when executed by the processor, cause at least one computing device to:
receive registration information from at least one potential transport agent, the registration information including information to uniquely identify the at least one potential transport agent;
determining, based on the received registration information, whether the at least one potential transport agent is authorized to be a transport agent;
responsive to determining that the at least one potential transport agent is authorized to be a transport agent:
receive, by a second entity, an indication of a deposit of funds being transported from a first entity to an unattended deposit system of the second entity by the at least one transport agent, the deposit of funds including at least one unique identifier associated with it;
receive, from the at least one transport agent, identifying information, the identifying information including at least biometric data of the at least one transport agent received from the biometric scanner;
authenticating the at least one transport agent by comparing the identifying information received from the transport agent with the registration information received to determine whether a match exists;
responsive to determining that a match exists, recording a presence of the at least one transport agent at the unattended deposit system and permitting deposit of the funds; and
responsive to determining that a match does not exist, recording an authentication attempt in a log and preventing the at least one transport agent from depositing the funds.

2. The system of claim 1, wherein receiving the registration information includes receiving at least a name of the at least one potential transport agent and biometric data of the at least one potential transport agent.

3. The system of claim 1, wherein determining, based on the received registration information, whether the at least one potential transport agent is authorized to be a transport agent further includes:
conducting a background check of the at least one transport agent, the background check including evaluating at least one of: a criminal history and a credit history of the at least one transport agent;
determining, based on the conducted background check, whether any issues of the at least one transport agent are identified;
responsive to determining that no issues of the at least one transport agent are identified, authorizing the at least one transport agent to be a transport agent; and
responsive to determining that one or more issues of the at least one transport agent are identified, preventing the at least one potential transport agent from being a transport agent and providing an indication to the at least one potential transport agent.

4. The system of claim 1, wherein the received biometric data includes at least one of: a fingerprint, a retinal scan, and a facial scan.

5. The system of claim 1, wherein recording a presence of the at least one transport agent at the unattended deposit system and permitting deposit of the funds further includes associating the unique identifier of the deposit of funds with the transport agent and storing the associated information.

6. The system of claim 1, wherein receiving an indication of a deposit of funds being transported from a first entity to an unattended deposit system of the second entity by the at least one transport agent further including initiating a deposit transaction including the deposit of the funds.

7. The system of claim 6, wherein the indication of the deposit of funds is received from a computing device of the first entity.

8. The system of claim 6, wherein the indication of the deposit of funds is received from the transport agent at the unattended deposit system of the second entity.

9. The system of claim 1, wherein the second entity is a financial institution.

10. A system, comprising:
a biometric scanner;
a processor;
a memory operatively coupled to the processor and storing computer-executable instructions that, when executed by the processor, cause at least one computing device to:
receive an indication of a deposit of funds at an unattended deposit system, the indication of the deposit of funds including initiation of a deposit transaction;
receive, by a second entity and from a first entity, funds for deposit in the unattended deposit system, the funds for deposit being transferred from the first entity to the second entity by a transport agent;
prior to further processing the initiated deposit transaction, request identifying information of the transport agent, the identifying information including at least biometric data of the transport agent;
store the identifying information including the at least biometric data of the transport agent;
further process the initiated deposit transaction, further processing including determining whether any issues with the deposit transaction are identified;
responsive to determining that no issues with the deposit transaction are identified, complete the deposit transaction and deleting the stored identifying information including the at least biometric data of the transport agent; and
responsive to determining that issues with the deposit transaction are identified, retrieving the stored identifying information including the at least biometric data of the transport agent and using the retrieved identifying information in an investigation of the identified issues.

11. The system of claim 10, wherein the biometric data includes at least one of: a fingerprint, a retinal scan, and a facial scan.

12. The system of claim 10, further including instructions that, when executed, cause the at least one computing device to:
responsive to receiving the deposit of funds, assign a unique identifier to the initiated deposit transaction; and
wherein storing the identifying information including the at least biometric data of the transport agent further includes storing the unique identifier of the initiated deposit transaction with the identifying information.

13. The system of claim 10, wherein the identifying information including at least biometric data of the transport agent is received by the system after the funds for deposit have been received and wherein the storing the identifying information including at least biometric data of the transport agent is performed after the funds for deposit have been received.

14. The system of claim 10, wherein completing the initiated deposit transaction includes depositing the funds received in an account of the first entity and making a full amount of the funds for deposit available for withdrawal.

15. A method, comprising:
receiving, by an unattended deposit system of a second entity, the unattended deposit system having at least one processor and from a transport agent, first identifying information of the transport agent, the first identifying information including biometric data of the transport agent;
storing, by the unattended deposit system, the received identifying information;
receiving, by the unattended deposit system, an indication of a deposit of funds being transported from a first entity to the second entity by the transport agent, the deposit of funds including at least one unique identifier associated with it;
receiving, by the unattended deposit system and from the transport agent, second identifying information, the second identifying information including at least biometric data of the transport agent received from a biometric scanner;
authenticating the transport agent by comparing the first identifying information received from the transport agent with the second identifying information received to determine whether a match exists;
responsive to determining that a match exists, recording a presence of the at least one transport agent at the unattended deposit system and permitting deposit of the funds; and
responsive to determining that a match does not exist, recording an authentication attempt in a log and preventing the at least one transport agent from depositing the funds.

16. The method of claim 15, wherein the second identifying information is received from the transport agent while the transport agent is present at the unattended deposit system.

17. The method of claim 16, wherein the first identifying information is received prior to the transport agent arriving at the unattended deposit system.

18. The method of claim 15, wherein the received biometric data includes at least one of: a fingerprint, a retinal scan, and a facial scan.

19. The method of claim 1, wherein recording a presence of the at least one transport agent at the unattended deposit system and permitting deposit of the funds further includes associating the unique identifier of the deposit of funds with the transport agent and storing the associated information.

20. The method of claim 15, wherein the second entity is a financial institution.
